(19) United States
(12) Patent Application Publication
(10) Pub. No.: US 2025/0043849 A1
(43) Pub. Date: Feb. 6, 2025

(54) DRIVELINE FOR A VEHICLE HAVING A TRANSMISSION WITH AT LEAST NINE SPEEDS

(71) Applicant: DANA GRAZIANO S.R.L., Rivoli (IT)

(72) Inventors: Davide CARPI, Rivoli (IT); Pier Paolo Paolo RINALDI, Rivoli (IT); Giorgio SCALICI, Rivoli (IT)

(21) Appl. No.: 18/789,401

(22) Filed: Jul. 30, 2024

(30) Foreign Application Priority Data
Jul. 31, 2023 (DE) 20 2023 104 326.7

(51) Int. Cl. F16H 3/091; F16H 3/12; F16H 61/00

(52) U.S. Cl. CPC F16H 3/091; F16H 3/12; F16H 61/0059; F16H 2200/0065

(57) ABSTRACT

The present disclosure relates to a driveline for a vehicle having a transmission with at least nine speeds, the driveline comprising an input shaft, an intermediate shaft having three intermediate gears rigidly connected thereto, an output shaft and a vehicle output, wherein the input shaft is drivingly connectable to the vehicle output by drivingly connecting the input shaft to the output shaft via the intermediate shaft, and by drivingly connecting the intermediate shaft to the vehicle output via the output shaft.

### CROSS REFERENCE TO RELATED APPLICATION

The present application claims priority to German Patent Application No. 20 2023 104 326.7, entitled “DRIVELINE FOR A VEHICLE HAVING A TRANSMISSION WITH AT LEAST NINE SPEEDS”, filed on Jul. 31, 2023. The entire contents of the above-listed application is hereby incorporated by reference for all purposes.

### TECHNICAL FIELD

The present disclosure relates to a driveline for a vehicle having a transmission with at least nine speeds.

### BACKGROUND AND SUMMARY

A power source for an automotive vehicle such as an internal combustion engine (ICE) may be operated over a wide range of output speeds. For example, a four-stroke compression ignition engine for passenger-car applications typically idles at around 600 rpm whereas its top speed is typically around 4000 rpm. And an engine for a commercial vehicle unit typically idles at around 500 rpm and may reach a maximum speed of around 2400 rpm. Whichever the application, the speed range of a power source in which energy or fuel consumption is at a minimum typically makes up a small fraction of the total speed range of the power source. In order to increase driveline efficiency, this fact has given rise to the trend of designing transmissions which offer an ever higher number of speed ratios. For example, it is now common for passenger cars to have a manual transmission (MT) with up to six forward speeds, an automatic transmission (AT) with up to nine speeds, a dual clutch transmission (DCT) with up to eight speeds, or an automated manual transmission (AMT) with up to eight speeds. In the field of commercial vehicles, these figures can be more than doubled.

However, transmissions offering a large number of speed ratios often come at the cost of an expensive, heavy and bulky lay-out. In some cases, these disadvantageous side effects may not compensate the advantage of increased in energy efficiency.

Thus, there is demand for a driveline for a vehicle offering both a high degree of energy efficiency and a low degree of complexity.

This demand is met by a driveline as described herein.

The presently proposed driveline for a vehicle having a transmission with at least nine speeds comprises an input shaft, an intermediate shaft having three intermediate gears rigidly connected thereto, an output shaft and a vehicle output. The input shaft is drivingly connectable to the vehicle output by drivingly connecting the input shaft to the output shaft via the intermediate shaft, and by drivingly connecting the intermediate shaft to the vehicle output via the output shaft.

The input shaft, the intermediate shaft and the output shaft may be arranged in parallel. For example, the output shaft may be arranged in a plane spanned by the input shaft and the intermediate shaft. Alternatively, the output shaft may be arranged outside of a plane spanned by the input shaft and the intermediate shaft. This may render the driveline more compact, for example.

The driveline may comprise three input gears disposed on the input shaft, the three input gears including a first input gear, a second input gear, and a third input gear. A diameter of the second input gear may be greater than a diameter of the first input gear, and a diameter of the third input gear may be greater than a diameter of the second input gear.

Each of the input gears may be drivingly connected to or in mesh with one of the intermediate gears. For example, the three intermediate gears may include a first intermediate gear, a second intermediate gear, and a third intermediate gear. A diameter of the second intermediate gear may be smaller than a diameter of the first intermediate gear, and a diameter of the third intermediate gear may be smaller than a diameter of the second intermediate gear. The first input gear may mesh with the first intermediate gear, the second input gear may mesh with the second intermediate gear, and the third input gear may mesh with the third intermediate gear.

The driveline may include an input engagement assembly configured to selectively engage either one of the three input gears with the input shaft. The input engagement assembly may include a first input selector device disposed on the input shaft and configured to selectively engage either one of a first input gear and a second input gear of the three input gears with the input shaft. The input engagement assembly may further include a second input selector device disposed on the input shaft and configured to selectively engage a third input gear of the three input gears with the input shaft. For example, the first input selector device may include a first input synchromesh unit, and/or the second input selector device may include a second input synchromesh unit.

The driveline may comprise three output gears disposed on the output shaft, the three output gears including a first output gear, a second output gear, and a third output gear. Each of the output gears may be drivingly connected to or in mesh with one of the intermediate gears. The first output gear may mesh with the first intermediate gear, the second output gear may mesh with the second intermediate gear, and the third output gear may mesh with the third intermediate gear.

The driveline may include an output engagement assembly configured to selectively engage either one of the three output gears with the output shaft. The output engagement assembly may include a first output selector device disposed on the output shaft and configured to selectively engage either one of a first output gear and a second output gear of the three output gears with the output shaft. The output engagement assembly may further include a second output selector device disposed on the output shaft and configured to selectively engage a third output gear of the three output gears with the output shaft. For example, the first output selector device may include a first output synchromesh unit, and/or the second output selector device may include a second output synchromesh unit.

The driveline may further include a control unit configured to control the input engagement assembly and the output engagement assembly to simultaneously engage only one of the input gears with the input shaft and only one of the output gears with the output shaft.

Additionally or alternatively, the control unit may be configured to realize a park lock by causing the input engagement assembly to simultaneously engage two of the input gears with the input shaft and, simultaneously, causing the output engagement assembly to engage at least one of the output gears with the output shaft.

And additionally or alternatively, the control unit may be configured to realize a park lock by causing the output engagement assembly to simultaneously engage two of the output gears with the output shaft.

The driveline may further include a power source. The power source may be drivingly connectable to the intermediate shaft via the input shaft. The power source may include at least one of an internal combustion engine and an electric motor. The vehicle output may include at least one of a differential, a reduction drive and one or more drive wheels, for example.

Embodiments of the presently proposed driveline is depicted in the figures and described in the following detailed description.

### BRIEF DESCRIPTION OF THE FIGURES

FIG. 1 schematically shows a driveline for an automotive vehicle.

FIG. 2 schematically shows details of a transmission of the driveline of FIG. 1.

FIG. 3A schematically shows a side view of the transmission.

FIG. 3B schematically shows a side view of the transmission.

FIG. 4 shows a table listing technical parameters of the transmission.

FIG. 5A schematically shows the transmission in a first gear.

FIG. 5B schematically shows the transmission in a second gear.

FIG. 6 shows a table listing a state of gears of the transmission corresponding to different speed ratios of the transmission.

### DETAILED DESCRIPTION

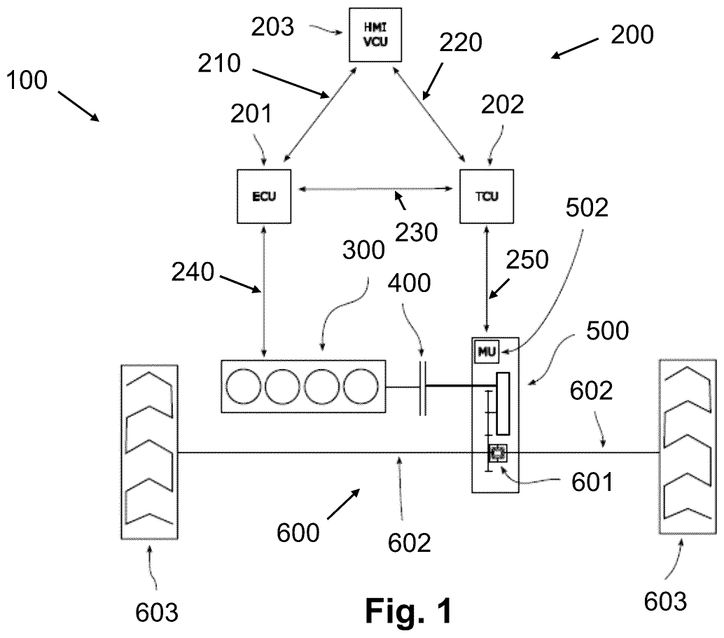

FIG. 1 schematically shows a driveline 100 of the presently proposed type. The driveline 100 may be disposed in a passenger car. However, it is understood that the driveline 100 may likewise be disposed in a commercial vehicle such as a truck or a bus, in an off-highway vehicle such as a loader or a dumper, or in any other type of automotive vehicle.

Here, the driveline 100 includes a power source 300 such as an internal combustion engine, a nine-speed transmission 500, for example an automated manual transmission (AMT), a clutch 400 selectively drivingly connecting the power source 300 to the transmission 500, and a vehicle output 600. It is understood that in some embodiments the power source 300 may include an electric motor instead of or in addition to an internal combustion engine. The vehicle output may include at least one of a differential 601, half shafts 602, and wheels 603, for example. In the embodiment depicted in the figures, the transmission 500 includes a mechatronic unit (MU) 502. The MU 502 may comprise actuators such as for operating the clutch 400 and/or for operating gear selector devices of the transmission 500. The MU 502 may further comprise sensors such as speed sensors for determining the speed of one or more rotating components of the transmission 500, and/or position sensors for determining a state or position of the actuators of the transmission 500.

The driveline 100 further includes a control unit 200. In the embodiment depicted here, the control unit 200 includes an engine control unit (ECU) 201, a transmission control unit (TCU) 202 and a vehicle control unit (VCU) 203, the VCU 203 comprising a human-machine interface (HMI). It is understood that in alternative embodiments the control unit 200 may include only a single unit or any other number of separate units. The ECU 201, the TCU 202 and the VCU 203 are in communication with one another, with the power source 300, and with the transmission 500, for example with the MU 502 of the transmission 500, via wired or wireless communication pathways 210, 220, 230, 240, 250. That is, in the embodiment depicted in the figures, the control unit 200 is configured to control the transmission 500, for example the MU 502 of the transmission 500.

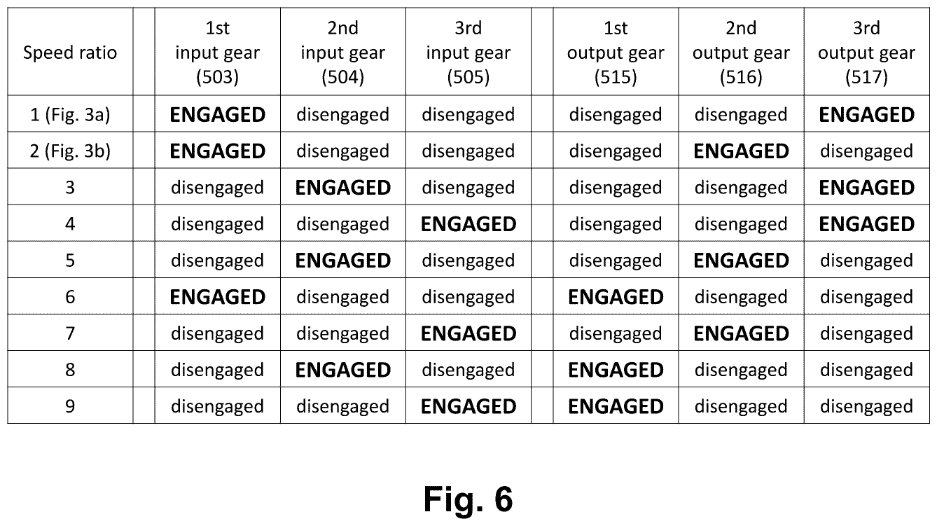

The ECU 201, the TCU 202 and the VCU 203 may interact to realize a control strategy. The ECU, TCU, and VCU may each include a processor and memory holding instructions for carrying out the various operations as described herein, including the gear/clutch positions of FIG. 6 and actuator commands to achieve the various gear ratios illustrated. For instance, the TCU 202 may be configured to determine a current gear ratio or speed ratio of the transmission 500 and command the MU 502 to carry out a gear shift. For example, the control unit 200 may operate the power source 300 in torque control, wherein the ECU 201 determines a torque set point, for example based on an accelerator pedal position received from the HMI of the VCU 203. When the TCU 202 receives a shift request from the HMI of the VCU 203 (e.g. a trigger from a paddle shifter), the ECU 201 may operate the power source 300 in speed control, wherein the TCU 202 provides a speed set point and causes the MU 502 to open the clutch 400 and to operate the shift actuators of the transmission 500. Alternatively, the HMI of the VCU 203 may provide a torque set point based on an accelerator pedal position, and the VCU 203 may command the shifting continuously, for example such as to minimize fuel or energy consumption of the power source 300.

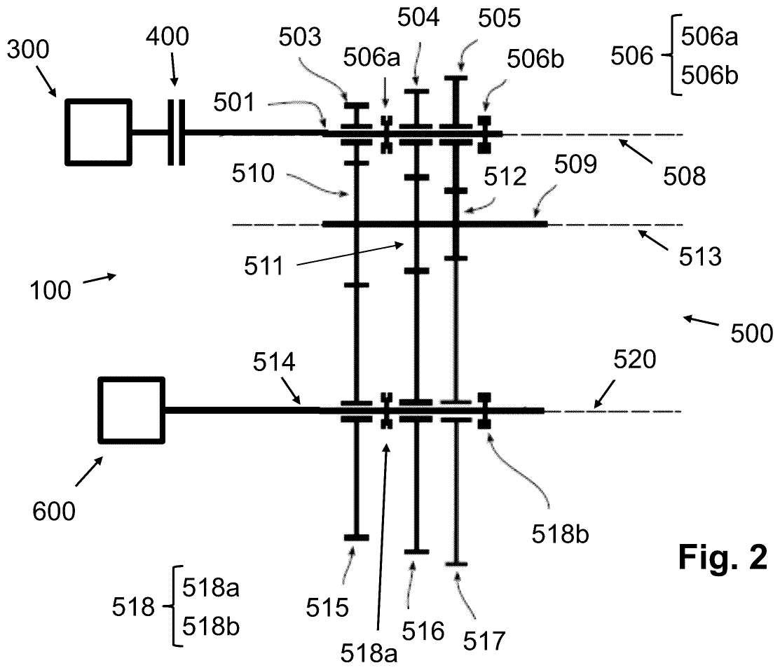

FIG. 2 shows another schematic of the driveline 100 of FIG. 1 including a more detailed view of the transmission 500 of FIG. 1. For illustrative purposes only, the control unit 200 and the MU 502 are not shown in FIG. 2. Here and in all of the following, features recurring in different figures are designated with the same reference signs.

The transmission 500 comprises an input shaft 501, an intermediate shaft 509, and an output shaft 514. The input shaft 501 is selectively drivingly connectable to the power source 300 via the clutch 400. And the output shaft 514 is drivingly connected to the vehicle output 600, for example to the differential 601 of the vehicle output 600. The input shaft 501, the intermediate shaft 509, and the output shaft 514 are arranged in parallel. Or in other words, the input shaft 501 is arranged in parallel to the intermediate shaft 509, and the intermediate shaft 509 is arranged in parallel to the output shaft 514.

The transmission 500 further comprises a first input gear 503, a second input gear 504, and a third input gear 505. Each of the input gears 503, 504, 505 is disposed on the input shaft 501. The input shaft 501 and the input gears 503, 504, 505 have a common axis of rotation 508. Each of the input gears 503, 504, 505 may selectively rotate with respect to the input shaft 501. In the embodiment illustrated here, a diameter of the second input gear 504 is greater than a diameter of the first input gear 503, and a diameter of the third input gear 505 is greater than a diameter of the second input gear 504.

The transmission 500 further comprises an input engagement assembly 506 which is configured to selectively engage either one of the input gears 503, 504, 505 with the input shaft 501 in a torque-proof manner. Here, the input engagement assembly 506 is controllable via the MU 502 of the transmission 500. When the input engagement assembly 506 engages one of the input gears 503, 504, 505 with the input shaft 501, the input gear engaged with the input shaft 501 co-rotates with the input shaft 501. In the embodiment depicted in the figures, the input engagement assembly 506 includes a first input selector device 506a and a second input selector device 506b, each disposed on the input shaft 501. Here, each of the first input selector device 506a and the second input selector device 506b comprises a synchromesh unit. It is understood that in other embodiments not explicitly depicted here, the input selector devices 506a, 506b may alternatively include devices other than synchromesh units for selectively drivingly engaging the input gears 503, 504, 505 with the input shaft, such as dog clutches, or the like. Along the axis of rotation 508 of the input shaft 501, the first input selector device 506a is disposed in between the first input gear 503 and the second input gear 504. The first input selector device 506a is configured to selectively engage either one of the first input gear 503 and the second input gear 504 with the input shaft 501. The second input selector device 506b is configured to selectively engage the third input gear 505 with the input shaft 501.

The transmission 500 further comprises a first intermediate gear 510, a second intermediate gear 511, and a third intermediate gear 512. Each of the intermediate gears 510, 511, 512 is rigidly connected to the intermediate shaft 509 in a torque-proof manner and co-rotates with the intermediate shaft 509. Alternatively, the intermediate gears 510, 511, 512, or at least one or more of the intermediate gears 510, 511, 512, may be formed in one piece with the intermediate shaft 509. The intermediate shaft 509 and the intermediate gears 510, 511, 512 have a common axis of rotation 513. In the embodiment illustrated here, a diameter of the second intermediate gear 511 is smaller than a diameter of the first intermediate gear 510, and a diameter of the third intermediate gear 512 is smaller than a diameter of the second intermediate gear 511. The first intermediate gear 510 meshes with the first input gear 503. The second intermediate gear 511 meshes with the second input gear 504. And the third intermediate gear 512 meshes with the third input gear 505.

The transmission 500 further comprises a first output gear 515, a second output gear 516, and a third output gear 517. Each of the output gears 515, 516, 517 is disposed on the output shaft 514. The output shaft 514 and the output gears 515, 516, 517 have a common axis of rotation 520. Each of the output gears 515, 516, 517 may selectively rotate with respect to the output shaft 514. In the embodiment illustrated here, a diameter of the second output gear 516 is greater than a diameter of the first output gear 515, and a diameter of the third output gear 517 is greater than a diameter of the second output gear 516. The first output gear 515 meshes with the first intermediate gear 510. The second output gear 516 meshes with the second intermediate gear 511. And the third output gear 517 meshes with the third intermediate gear 512.

The transmission 500 further comprises an output engagement assembly 518 which is configured to selectively engage either one of the output gears 515, 516, 517 with the output shaft 514. Here, the output engagement assembly 518 is controllable via the MU 502 of the transmission 500. When the output engagement assembly 518 engages one of the output gears 515, 516, 517 with the output shaft 514, the output gear engaged with the output shaft 514 co-rotates with the output shaft 514. In the embodiment depicted in the figures, the output engagement assembly 518 includes a first output selector device 518a and a second output selector device 518b, each disposed on the output shaft 514. Here, each of the first output selector device 518a and the second output selector device 518b comprises a synchromesh unit. It is understood that in other embodiments not explicitly depicted here, the output selector devices 518a, 518b may alternatively include devices other than synchromesh units for selectively drivingly engaging the output gears 515, 516, 517 with the output shaft 514, such as dog clutches, or the like. Along the axis of rotation 520 of the output shaft 514, the first output selector device 518a is disposed in between the first output gear 515 and the second output gear 516. The first output selector device 518a is configured to selectively engage either one of the first output gear 515 and the second output gear 516 with the output shaft 514. The second output selector device 518b is configured to selectively engage the third output gear 517 with the output shaft 514.

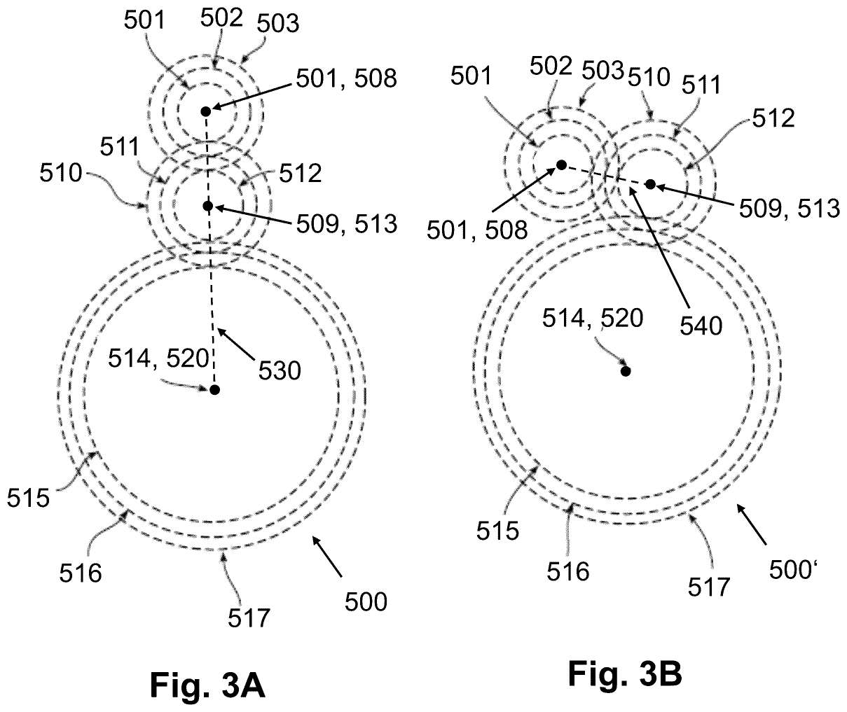

FIG. 3A schematically shows a side view of the transmission 500, wherein the direction of view is along the parallel axes of rotation 508, 513 and 520 of the input shaft 501, the intermediate shaft 509, and the output shaft 514, respectively. In the embodiment illustrated in FIG. 3A, the input shaft 501, the intermediate shaft 509, and the output shaft 514 are disposed in one plane 530.

FIG. 3B schematically shows a side view of an embodiment of a transmission 500′, which is a variation of the transmission 500 of FIG. 3A. Unless explicitly stated to the contrary, the transmission 500′ of FIG. 3B includes the same features as the transmission 500 of FIG. 3A. Again, the direction of view of FIG. 3B is along the parallel axes of rotation 508, 513 and 520 of the input shaft 501, the intermediate shaft 509, and the output shaft 514, respectively. The embodiment of the transmission 500′ illustrated in FIG. 3B differs from the embodiment of the transmission 500 illustrated in FIG. 3A in that in the transmission 500′ of FIG. 3B the output shaft 514 is arranged outside of and at a distance from a plane 540 spanned by the input shaft 501 and the intermediate shaft 509.

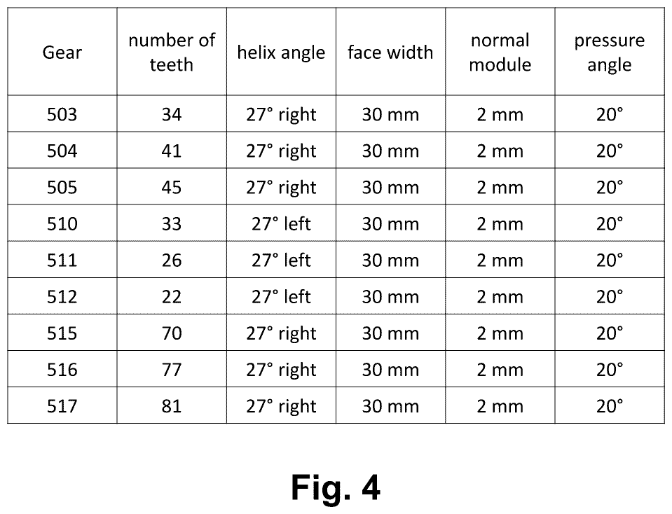

FIG. 4 shows a table listing some technical details of the input gears 503, 504, 505, the intermediate gears 510, 511, 512, and the output gears 515, 516, 517 in an embodiment of the transmission 500.

Notably, and in contrast to other nine-speed transmissions known from the prior art, the transmissions 500, 500′ shown in the figures realize nine different speed ratios, e.g. forward speed ratios, between the input shaft 501 and the output shaft 514 with only nine gears, namely the three input gears 503, 504, 505, the three intermediate gears 510, 511, 512, and the three output gears 515, 516, 517. In this manner, the presently proposed driveline 100 and transmission 500 realize a high degree of energy or fuel efficiency and, at the same time, a low degree of complexity, size and weight, thereby significantly reducing production costs and maintenance costs.

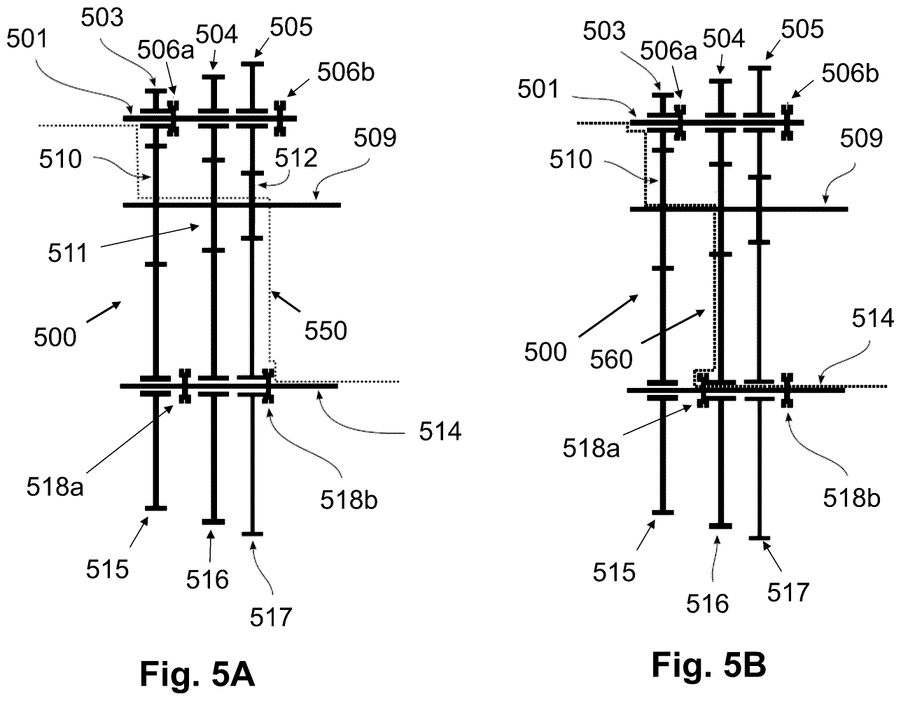

As an example of a gear shift in the transmission 500, FIG. 5A shows the transmission 500 in a first gear having a first speed ratio r₁=ω_{1,out}/ω_{1,in} between the output shaft 514 and the input shaft 501, and FIG. 5B shows the transmission 500 in a second gear having a second speed ratio r₂=ω_{2,out}/ω_{2,in} between the output shaft 514 and the input shaft 501, wherein ωₒᵤₜ and ωᵢₙ denote the angular velocity of the output shaft 514 and of the input shaft 501, respectively. Here, the second speed ratio of the transmission 500 depicted in FIG. 5B is greater than the first speed ratio of the transmission 500 depicted in FIG. 5A.

When the transmission 500 is in the first gear, as depicted in FIG. 5A, the input engagement assembly 506, more specifically the first input selector device 506a, engages the first input gear 503 with the input shaft 501 in a torque-proof manner. At the same time, the input engagement assembly 506 leaves the second input gear 504 and the third input gear 505 disengaged, thereby allowing the input gears 504, 505 to rotate freely with respect to the input shaft 501. Further in FIG. 5A, the output engagement assembly 518, more specifically the second output selector device 518b, engages the third output gear 517 with the output shaft 514 in a torque-proof manner. At the same time, the output engagement assembly 518 leaves the first output gear 515 and the second output gear 516 disengaged, thereby allowing the output gears 515, 516 to rotate freely with respect to the output shaft 514. That is, in the first gear of the transmission 500 depicted in FIG. 5A, torque may be transmitted from the input shaft 501 to the output shaft 514 via the first input gear 503, the first intermediate gear 510, the intermediate shaft 509, the third intermediate gear 512, and the third output gear 517, as indicated by the dotted line 550 in FIG. 5A.

When the transmission 500 is in the second gear, as depicted in FIG. 5B, the input engagement assembly 506 is in the same state as in the first gear of the transmission 500 depicted in FIG. 5A. However, in contrast to the arrangement illustrated in FIG. 5A, in the second gear of the transmission 500 illustrated in FIG. 5B, the output engagement assembly 518, more specifically the first output selector device 518a, engages the second output gear 516 with the output shaft 514 in a torque-proof manner. At the same time, the output engagement assembly 518 leaves the first output gear 515 and the third output gear 517 disengaged, thereby allowing the output gears 515, 517 to rotate freely with respect to the output shaft 514. That is, in the second gear of the transmission 500 depicted in FIG. 5B, torque may be transmitted from the input shaft 501 to the output shaft 514 via the first input gear 503, the first intermediate gear 510, the intermediate shaft 509, the second intermediate gear 511, and the second output gear 516, as indicated by the dotted line 560 in FIG. 5B.

FIG. 6 shows a table listing the state of each of the input gears 503, 504, 505 and of each of the output gears 515, 516, 517 for each of the nine speed ratios of the transmission 500, wherein the state of the gears is either engaged or disengaged. FIG. 6 illustrates that in each of the nine gears or speed ratios of the transmission 500 exactly one of the three input gears 503, 504, 505 is engaged with the input shaft 501 while the other two input gears are disengaged from the input shaft 501, and exactly one of the three output gears 515, 516, 517 is engaged with the output shaft 514 while the other two output gears are disengaged from the output shaft 514.

For example, shifting the transmission 500 from the first gear or first speed ratio depicted in FIG. 5A up to the second gear or second speed ratio depicted in FIG. 5B, that is to the next higher gear of the transmission 500, includes
the control unit 200 causing the clutch 400 to open,
the control unit 200 causing the second output selector device 518b to transfer or move to a neutral state to disengage the third output gear 517 from the output shaft 514,
the control unit 200 causing the first output selector device 518a to transfer or move to an engaged state to engage the second output gear 516 with the output shaft 514, and
the control unit 200 causing the clutch 400 to close.

Analogously, shifting the transmission 500 from the second gear or second speed ratio depicted in FIG. 5B down to the first gear or first speed ratio depicted in FIG. 5A, that is to the next lower gear of the transmission 500, includes
the control unit 200 causing the clutch 400 to open,
the control unit 200 causing the first output selector device 518a to transfer or move to a neutral state to disengage the second output gear 516 from the output shaft 514,
the control unit 200 causing the second output selector device 518b to transfer or move to an engaged state to engage the third output gear 517 with the output shaft 514, and
the control unit 200 causing the clutch 400 to close.

In another example, shifting the transmission 500 from the fourth gear or fourth speed ratio up to the fifth gear or fifth speed ratio (see FIG. 6), that is to the next higher gear of the transmission 500, includes
the control unit 200 causing the clutch 400 to open,
the control unit 200 causing the second input selector device 506b to transfer or move to a neutral state to disengage the third input gear 505 from the input shaft 501,
the control unit 200 causing the second output selector device 518b to transfer or move to a neutral state to disengage the third output gear 517 from the output shaft 514,
the control unit 200 causing the first input selector device 506a to transfer or move to an engaged state to engage the second input gear 504 with the input shaft 501,
the control unit 200 causing the first output selector device 518a to transfer or move to an engaged state to engage the second output gear 516 with the output shaft 514, and
the control unit 200 causing the clutch 400 to close.

Analogously, shifting the transmission 500 from the fifth gear or fifth speed ratio down to the fourth gear or fourth speed ratio (see FIG. 6), that is to the next lower gear of the transmission 500, includes
the control unit 200 causing the clutch 400 to open,
the control unit 200 causing the first input selector device 506a to transfer or move to a neutral state to disengage the second input gear 504 from the input shaft 501,
the control unit 200 causing the first output selector device 518a to transfer or move to a neutral state to disengage the second output gear 516 from the output shaft 514,
the control unit 200 causing the second input selector device 506b to transfer or move to an engaged state to engage the third input gear 505 with the input shaft 501,
the control unit 200 causing the second output selector device 518b to transfer or move to an engaged state to engage the third output gear 517 with the output shaft 514, and
the control unit 200 causing the clutch 400 to close.

In order to reduce the time required to perform the shift between the fourth gear or fourth speed ratio and the fifth gear or fifth speed ratio, steps 2) and 3) may be carried out simultaneously. Additionally or alternatively, the steps 4) and 5) may be carried out simultaneously.

The driveline 100 may also be used to perform a non-sequential gear shift in the transmission 500. For example, shifting the transmission 500 from the ninth gear or ninth speed ratio down to the fourth gear or fourth speed ratio (see FIG. 6) includes:
the control unit 200 causing the clutch 400 to open,
the control unit 200 causing the first output selector device 518a to transfer or move to a neutral state to disengage the first output gear 515 from the output shaft 514,
the control unit 200 causing the second output selector device 518b to transfer or move to an engaged state to engage the third output gear 517 with the output shaft 514, and
the control unit 200 causing the clutch 400 to close.

Generally, performing a gear shift in the transmission 500 includes, in a first step, the control unit 200 causing one of the selector devices on the input shaft 501 or on the output shaft 514 to transfer or move to a neutral state to disengage a previously engaged gear, and, in a subsequent second step, the control unit 200 causing one of the selector devices on the same shaft to transfer or move to an engaged state to engage a previously disengaged gear. These steps can be carried out on only one of the input shaft 501 and the output shaft 514 (as in the above-described shift between the first and second gear), or on both the input shaft 501 and the output shaft 514 (as in the above-described shift between the fourth and fifth gear). Importantly, when shifting gears in the transmission 500 as the vehicle is travelling at a non-zero speed, only exactly one of the input gears 503, 504, 505 and only exactly one of the output gears 515, 516, 517 may be engaged at any given time in order to prevent locking the shafts of the transmission 500.

However, when the vehicle including the driveline 100 is at rest, the control unit 200 may operate the transmission 500 to function as a park lock. To that end, when the vehicle including the driveline 100 is at rest, the control unit 200 may cause the input engagement assembly 206 to simultaneously engage two of the input gears 503, 504, 505 with the input shaft 501 and, simultaneously, cause the output engagement assembly 218 to engage at least one of the output gears 515, 516, 517 with the output shaft 514. Alternatively, when the vehicle including the driveline 100 is at rest, the control unit 200 may operate the transmission 500 to function as a park lock by causing the output engagement assembly 218 to simultaneously engage two of the output gears 515, 516, 517 with the output shaft.

1. Driveline for a vehicle having a transmission with at least nine speeds, the driveline comprising an input shaft, an intermediate shaft having three intermediate gears rigidly connected thereto, an output shaft and a vehicle output, wherein the input shaft is drivingly connectable to the vehicle output by drivingly connecting the input shaft to the output shaft via the intermediate shaft, and by drivingly connecting the intermediate shaft to the vehicle output via the output shaft.

2. The driveline of claim 1, wherein the input shaft, the intermediate shaft and the output shaft are arranged in parallel.

3. The driveline of claim 2, wherein the input shaft, the intermediate shaft and the output shaft lie in one plane.

4. The driveline of claim 2, wherein the output shaft is arranged outside of a plane spanned by the input shaft and the intermediate shaft.

5. The driveline of claim 1, further comprising three input gears disposed on the input shaft, wherein each of the three input gears is drivingly connected to one or more intermediate gears.

6. The driveline of claim 5, wherein each of the three input gears is in mesh with the one or more intermediate gears.

7. The driveline of claim 5, further including an input engagement assembly configured to selectively engage one or more of the three input gears with the input shaft.

8. The driveline of claim 7, wherein the input engagement assembly includes a first input selector device disposed on the input shaft and configured to selectively engage either one of a first input gear and a second input gear of the three input gears with the input shaft.

9. The driveline of claim 8, wherein the input engagement assembly includes a second input selector device disposed on the input shaft and configured to selectively engage a third input gear of the three input gears with the input shaft.

10. The driveline of claim 8, wherein the input engagement assembly includes a second input selector device disposed on the input shaft, and wherein the first input selector device includes a first input synchromesh unit, and wherein the second input selector device includes a second input synchromesh unit.

11. The driveline of claim 1, further comprising three output gears disposed on the output shaft, wherein each of the three output gears is drivingly connected to one or more intermediate gears.

12. The driveline of claim 11, wherein each of the three output gears is in mesh with one of the one or more intermediate gears.

13. The driveline of claim 11, further including an output engagement assembly configured to selectively engage either one of the three output gears with the output shaft.

14. The driveline of claim 13, wherein the output engagement assembly includes a first output selector device disposed on the output shaft and configured to selectively engage either one of a first output gear and a second output gear of the three output gears with the output shaft.

15. The driveline of claim 14, wherein the output engagement assembly includes a second output selector device disposed on the output shaft and configured to selectively engage a third output gear of the three output gears with the output shaft.

16. The driveline of claim 15, wherein the first output selector device includes a first output synchromesh unit, and/or wherein the second output selector device includes a second output synchromesh unit.

17. The driveline of claim 6, further including a control unit configured to control an input engagement assembly and an output engagement assembly to simultaneously engage only one of the three input gears with the input shaft and only one of three output gears with the output shaft.

18. The driveline of claim 17, wherein the control unit is configured to realize a park lock by
causing the input engagement assembly to simultaneously engage two of the three input gears with the input shaft and, simultaneously,
causing the output engagement assembly to engage at least one of the three output gears with the output shaft;
and/or wherein the control unit is configured to realize the park lock by
causing the output engagement assembly to simultaneously engage two of the three output gears with the output shaft.

19. The driveline of claim 1, further including a power source, wherein the power source is drivingly connectable to the intermediate shaft via the input shaft, wherein the power source includes at least one of an internal combustion engine and an electric motor.

20. Driveline for a vehicle having a transmission with at least nine speeds, the driveline comprising an input shaft, an intermediate shaft having three intermediate gears rigidly connected thereto, an output shaft and a vehicle output, wherein the input shaft is drivingly connectable to the vehicle output by drivingly connecting the input shaft to the output shaft via the intermediate shaft, and by drivingly connecting the intermediate shaft to the vehicle output via the output shaft, the driveline further including a control unit configured to control an input engagement assembly and an output engagement assembly to simultaneously engage only one input gear with the input shaft and only one output gear with the output shaft.
